(19) United States
(12) Patent Application Publication
(10) Pub. No.: US 2007/0294376 A1
(43) Pub. Date: Dec. 20, 2007

(54) Method, apparatus and program product for software provisioning

(75) Inventors: Naga A. Ayachitula, Elmsford, NY (US); Larisa Shwartz, Scardale, NY (US); Maheswaren Surendra, Croiton-on-Hudson, NY (US)

Correspondence Address: DANIEL E. MCCONNELL;THE MCCONNELL LAW FIRM, 2115 ST. MARY'S STREET, RALEIGH, NC, 27606, US

(73) Assignee: INTERNATIONAL BUSINESS MACHINES CORPORATION, Armonk, NY (US)

(21) Appl. No.: 11/471,133

(22) Filed: Jun. 20, 2006

(51) Int. Cl. G06F 15/177

(52) U.S. Cl. 709/220

(57) ABSTRACT

A software provisioning model which effectively combines characteristics of both push and pull models. In response to a request, a server sends a workflow or recipe of actions along with code server parameters and a requesting client computer system executes the,workflow and pulls necessary software updates and services to the client.

### FIELD AND BACKGROUND OF INVENTION

As information technology infrastructure has increased in complexity, new technologies and expansion over time and growing services have introduced several challenges for managing enterprise operations, business processes, infrastructural changes, resource setup, configuration and service delivery for service providers. Service providers are often faced with problematic situations: a subscriber device may not support the service being accessed due to missing software components or incompatible software component versions. Similarly, setting up and operating the device may be too complex for the subscriber to manage on their own. Service availability and options typically vary based on policies, networks and location.

While there is a considerable focus in the IT industry on automation of enterprise networks and applications, there are significant gaps in system automation and provisioning in providing an open service platform conforming to standards like Open Service Gateway initiative (OSGi), Open Mobile Alliance Device Management (OMA DM) etc., for effectively managing multiple applications and provisioning services to all types of networked devices in home, vehicle, mobile and other environments.

“Provisioning”, as used here, relates to any providing of software—executables or manipulable data—to an end user device. A large majority of the system failures that disrupt critical business services result from unmanaged changes to the IT production environment. Twenty (20) percent of business critical downtime is caused by scheduled changes. That very well indicates the necessity of bringing automation into the world of modifications to resource setup and configuration.

Traditionally, provisioning has been a “push” model and server centric. The server centric approach limits the number of end-points that can be concurrently provisioned as it holds several resources during the provisioning lifecycle. There are scalability, performance, granular end-point control and resource usage issues in a server centric approach which can be solved by decentralizing orchestration from the server to the end-point client and leveraging the capabilities of the end-point client. One alternative is a “pull” model which is more end user device centric, but which is more dependent upon skilled end users and capable devices.

### SUMMARY OF THE INVENTION

With the foregoing in mind, one purpose of this invention is use a provisioning model which effectively combines characteristics of both push and pull models. Without taking the extreme approach of a client centric “pull” model, using both the “push” and ‘pull’ models can simplify continual provisioning of end point devices. A smart end-point device is not just an agent but a platform on which services can be hosted and services can collaborate with one another. By decentralizing provisioning, the server can send a workflow or the recipe of actions along with the code server parameters and an end point service can execute the workflow and pull necessary software updates and services to the client platform.

In realizing this invention, a smart client platform can use policy and planning services locally in case of failures without talking to the server. The server is notified only in a case where the local planners lack the knowledge to continue provisioning. Realizing a smart end point as a platform for service delivery, hosting and collaboration opens a realm of opportunities for service providers and simplifies autonomic service orchestration to the end point devices.

### BRIEF DESCRIPTION OF DRAWINGS

Some of the purposes of the invention having been stated, others will appear as the description proceeds, when taken in connection with the accompanying drawings, in which:

FIG. 1 is a schematic representation of a plurality of end point client system devices connected through a network with a server;

FIG. 2 is a second schematic representation of the interconnections and interactions between a plurality of end-point client system devices and a plurality of servers;

FIG. 3 is a representation of the steps of a method in accordance with this invention;

FIG. 4 is a representation of the relationship among certain subsystems employed in accordance with this invention for assuring that end-point client computer systems are properly provisioned prior to acceptance into a network environment; and

FIG. 5 is an optical disk on which is stored computer readable code implementing the-invention described here.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

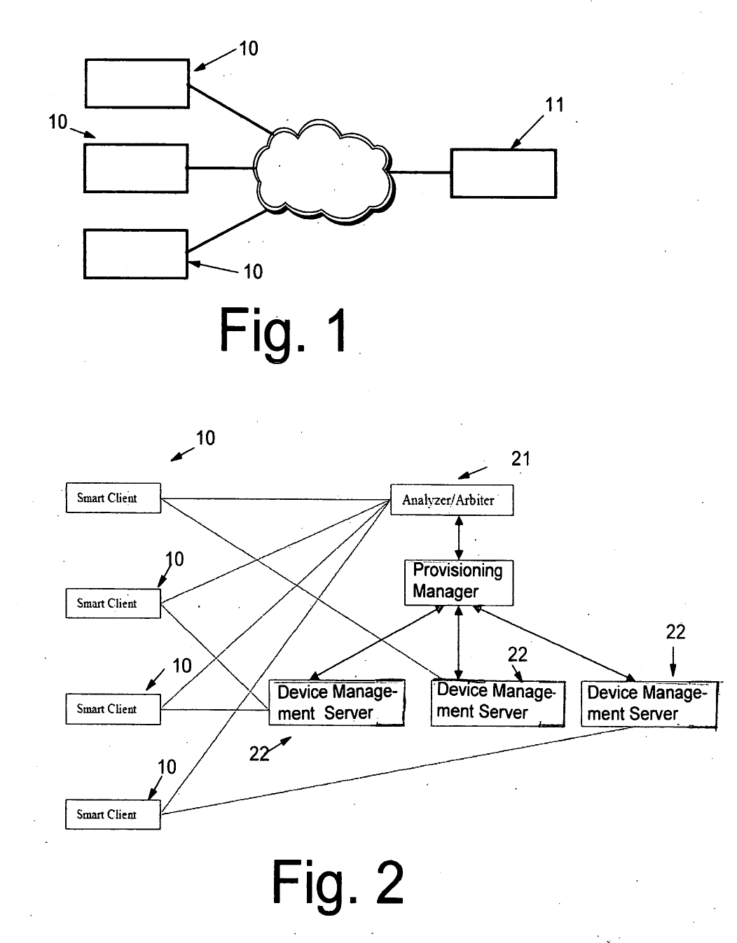

Referring now more particularly to FIG. 1, shown there are a plurality. of end point devices 10, each also here called a client computer system or end-point client. These devices can be PDAs, handheld PCs, wireless laptops, cell phones, set-top boxes, in-vehicle information systems, and other devices for pervasive computing. Each client computer system is connected through a network—wireless or wired—to one or more servers, represented here by a server 11. It will be understood by the knowledgeable reader that networks commonly have a plurality of servers supporting network activity, as will be the case with regards to this invention and as will be further discussed below.

The method of this invention, as more fully described below, involves originating at a client computer system a request for initiation of software provisioning for the client system; receiving at a server computer system the request for initiation of software provisioning of the originating client system; generating at the server system in response to the received request a worklist directing provisioning as appropriate for the requesting client system; transmitting the worklist to the requesting client system; and executing the worklist at the client system to obtain provisioning. As embodied in hardware, the invention comprises a client computer system; computer executable code stored accessibly to the client computer system and effective when executing on the client system to originate a request for initiation of software provisioning for the client system; a server computer system; computer executable code stored accessibly to the server computer system and effective when executing on the server system to receive at the server computer system the request for initiation of software provisioning of the client system; generate at the server system in response to the received request a worklist directing provisioning as appropriate for the client system; and transmit the worklist to the client system; and in which the client system executable code is effective to execute the worklist on the client system to obtain provisioning. As a program product, the invention comprises computer readable media such as an optical disk and computer executable code stored on the media and effective when executing on computer systems to implement the method and instantiate the apparatus here described.

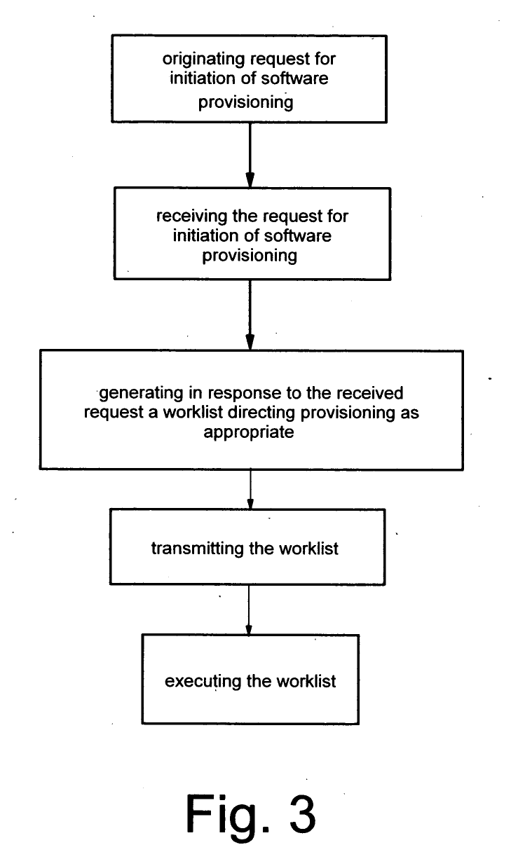

Referring now to FIGS. 2 and 3, a provisioning scenario may involve the following process:

The end-point client 10 generates a set of services that need provisioning.

The end-point client sends a request to an Analyzer/Arbiter 21.

The Analyzer/Arbiter 21 parses client input and transforms request parameters for further processing for workflows.

The Analyzer/Arbiter 21, based on the workload of the system, assigns a DMS server 22 from a DMS server pool and extracts the necessary parameters for device enrollment.

The Analyzer/Arbiter 21, together with an intelligent orchestrater (TIO)/provisioning manager (TPM) creates a workflow, passing it along with corresponding DMS server and end-point device specific parameters.

A workflow is executed by a Deployment Engine which does a look-up of the service artifacts in the Data Center Model.

A recipe of provisioning actions—the worklist—is generated by the workflow. Every action is transformed and submitted to a DMS server 22 as Provisioning Jobs.

The workflow sends a notification message via HTTP to the end-point client to pull the pending service jobs from the registered DMS code server.

The client computer connects to the corresponding DMS server account and ‘pulls’ the services to its runtime and starts the services.

Upon completion, the process notifies both the system and the end-user about the completion of provisioning.

The present invention contemplates handling certain problems which arise in enterprise environments where a large number of client computers may have at least some access to supporting servers. In such environments, protecting the perimeter is one of the key capabilities that enterprise customers are looking for. Protecting the enterprise from “rogue” devices is based on two key technology capabilities: disallow devices that do not meet policy for the network, and monitoring the behavior of devices. To ensure the businesses network security the state of a device should be checked before it can be connected. Any device, if it may cause harm or is a risk to the enterprise network should be disallowed. The further requirement for network access control is not only to detect the posture of the device connected to the network but also to correct the failure of a trusted device.

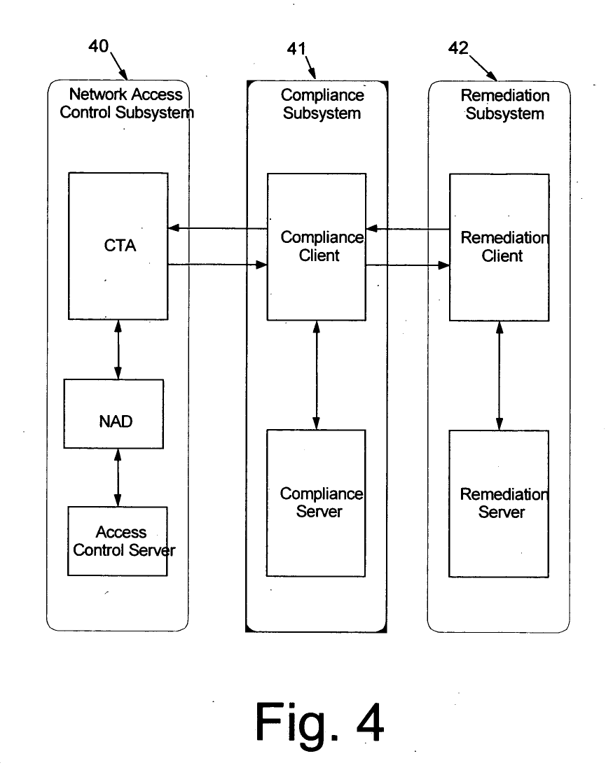

Referring now to FIG. 4, the present invention contemplates a solution that will deliver the capability to manage the security profile of enabled clients based on defined policies. This management will include detection of violations to policy (compliance) and corrections of these violations (remediation) by provisioning. As here proposed, an integrated solution includes a compliance manager and a provisioning manager as described to this point.

The inventive solution is divided into three subsystems, Network Access Control 40, Compliance Manager 41, and Remediation Manager 42. Each of the subsystems contains server-based and client-based components. The illustration in FIG. 4, distinct from those described above, groups the components by function rather than by place or system of execution. Thus each of the component modules as illustrated includes both client and server portions. The compliance client and remediation client are each packaged and installed separately, with the remediation client installed after the compliance client has been installed. All communications between client subsystems happens on the client end-point system itself. Each client is then responsible for all communications with its respective server(s).

The solution provides the capability to define a policy in the Compliance Manager (CM) 41 which will be used to determine a device's “posture” to be on the network. This policy will be evaluated at a device when the network asks the device for its current “posture”. The CM client agent will be asked for compliance information and will respond with the current “posture”. If the device is determined to be non-compliant, the network will move the device to an isolated “remediation” network, returning to the CM agent a token specifying location information for remediation. The provisioning manager described hereinabove will be triggered by the CM agent to remediate the device, activating the remediation subsystem 42. Once remediation is complete and the compliance posture is acceptable the device will be allowed entry to the secure “production” network.

An illustrative scenario starts with an endpoint connecting to the network. The Network Access Control 40 challenges the CM client agent for its compliance posture and the agent returns its posture and policy level. This posture and policy information is sent to a server via a private connection and the server will determine whether the data returned by the endpoint is compliant with the policy version and posture defined at the server. If the client is compliant, it is admitted onto the production network. If the device is not compliant, the device is placed in a special isolated remediation network and sent an address within that isolated network to use for remediation.

Once in the isolated Remediation network, the CM client and Remediation client communicate the compliance violations to a Remediation listener. The listener invokes the appropriate remediation workflows on the provisioning manager server and these then call the transport layer to perform the actual updates that will remediate the violations.

Once the remediation is complete, the CM Agent is notified of this completion. The CM Agent rescans the host for compliance and creates a new compliance posture. The NAC polls the client periodically and at the next polling cycle, the new compliance posture is returned by the CM Agent. Once the correct posture has been returned, the endpoint is admitted to the production network.

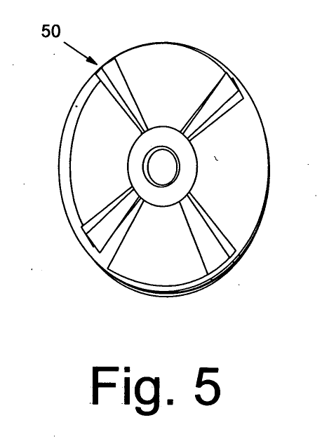

FIG. 5 illustrates a computer readable medium, in the form of an optical disk 50, on which is stored computer readable code when, when executing on appropriate computer systems, implements the invention described here.

In the drawings and specifications there has been set forth a preferred embodiment of the invention and, although specific terms are used, the description thus given uses terminology in a generic and descriptive sense only and not for purposes of limitation.

What is claimed is:

1. Method comprising:
originating at a client computer system a request for initiation of software provisioning for the client system;
receiving at a server computer system the request for initiation of software provisioning of the originating client system;
generating at the server system in response to the received request a worklist directing provisioning as appropriate for the requesting client system;
transmitting the worklist to the requesting client system; and
executing the worklist at the client system to obtain provisioning.

2. Method according to claim 1 wherein the originating of a request comprises generating a list of services that need provisioning.

3. Method according to claim 1 wherein the generating of a worklist comprises parsing the received request and assigning a provisioning server.

4. Method according to claim 1 wherein the executing of the worklist comprises pulling from a server the services appropriate to the requested provisioning.

5. Method according to claim 1 further comprising preceding the generation of the worklist by controlling network access by the client computer system.

6. Method according to claim 1 further comprising responding to a received request for initiation of provisioning by determining the state of the requesting client computer system and remediating the requesting client to conform to network access controls.

7. Apparatus comprising:
a client computer system;
computer executable code stored accessibly to said client computer system and effective when executing on said client system to:
originate a request for initiation of software provisioning for said client system;
a server computer system;
computer executable code stored accessibly to said server computer system and effective when executing on said server system to:
receive at said server computer system the request for initiation of software provisioning of said client system;
generate at the server system in response to the received request a worklist directing provisioning as appropriate for said client system; and
transmit the worklist to said client system;
said client system executable code further effective to execute the worklist on said client system to obtain provisioning.

8. Apparatus according to claim 7 wherein said computer executable code stored accessibly to said client computer system is effective when executing on said client system to generate a list of services that need provisioning.

9. Apparatus according to claim 7 wherein said computer executable code stored accessibly to said server computer system is effective when executing on said server system to parse the received request and assign a provisioning server.

10. Apparatus according to claim 7 wherein said computer executable code stored accessibly to said client computer system is effective when executing on said client system to execute the worklist by pulling from a server the services appropriate to the requested provisioning.

11. Apparatus according to claim 7 further comprising computer executable code stored accessibly to said client computer system and said server computer system and effective when executing on said client system and said server system to control network access by said client computer system.

12. Apparatus according to claim 7 further comprising computer executable code stored accessibly to said client computer system and said server computer system and effective when executing on said client system and said server system which responds to a received request for initiation of provisioning by determining the state of the requesting client computer system and remediating the requesting client to conform to network access controls.

13. Apparatus comprising:
computer readable media; and
computer executable code stored on said media and effective when executing on computer systems to:
originate a request for initiation of software provisioning for a client system;
receive at a server computer system the request for initiation of software provisioning of the client system;
generate at the server system in response to the received request a worklist directing provisioning as appropriate for the client system;
transmit the worklist from the server system to the client system; and
execute the worklist on the client system to obtain provisioning.

14. Apparatus according to claim 13 wherein said computer executable code is effective when executing on said client system to generate a list of services that need provisioning.

15. Apparatus according to claim 13 wherein said computer executable code is effective when executing on said server system to parse the received request and assign a provisioning server.

16. Apparatus according to claim 13 wherein said computer executable code is effective when executing on said client system to execute the worklist by pulling from a server the services appropriate to the requested provisioning.

17. Apparatus according to claim 13 wherein said computer executable code further comprises code effective when executing on said client system and said server system to control network access by said client computer system.

18. Apparatus according to claim 13 wherein said computer executable code further comprises code effective when executing on said client system and said server system which responds to a received request for initiation of provisioning by determining the state of the requesting client computer system and remediating the requesting client to conform to network access controls.
